(19) United States
(12) Patent Application Publication
(10) Pub. No.: US 2010/0201146 A1
(43) Pub. Date: Aug. 12, 2010

(54) Mobile Dance Studio

(76) Inventor: Amiya J. Alexander, Southfield, MI (US)

Correspondence Address: THE WEINTRAUB GROUP, P.L.C., 28580 Orchard Lake Road, Suite 140, Farmington Hills, MI, 48334, US

(21) Appl. No.: 12/701,791

(22) Filed: Feb. 8, 2010

Related U.S. Application Data
(60) Provisional application No. 61/207,023, filed on Feb. 6, 2009.

(51) Int. Cl. B60P 3/00

(52) U.S. Cl. 296/24.3

(57) ABSTRACT

The present invention provides a mobile dance studio located within a vehicle. The mobile dance studio generally comprises a dance floor, a reflective surface, a balance barre, and a music system. The dance floor, reflective surface, balance barre, and music system are secured within the vehicle such that the vehicle may easily and quickly be moved from one location to another. The vehicle may optionally also include an office having items such as a desk, a chair, and means for collecting and tracking payment as well as tracking student enrollment. The vehicle may optionally further include a dressing room in which students may prepare for class by changing into appropriate dance attire.

### CROSS REFERENCE TO RELATED APPLICATION

This application claims the benefit of U.S. Provisional Application 61/207,023, which was filed on Feb. 6, 2009, the entire disclosure of which is hereby incorporated by reference, including the specification and drawings.

### BACKGROUND OF THE INVENTION

1. Field of the Invention

The present invention pertains to a mobile dance studio. More particularly, the present invention pertains to a vehicle equipped as a mobile dance studio including a dance floor, a reflective surface, a balance barre, and a music system.

2. Description of the Prior Art

Mobile units for providing services are known in the art. For instance, U.S. Pat. No. 5,706,616 to Fernandez discloses a mobile movie theater. The mobile movie theater is assembled on a large trailer and provides theater seating, a viewing screen, and a projector. The mobile movie theater has semi-permanent fixtures and is capable of being moved from one location to another so as to display a movie at one location, be moved, and then display a movie at a second location.

However, there are a limited number of services which are provided by mobilized units, and it is desirable to provide additional services via mobile units so as to provide patrons with added convenience. It is especially desirable when the patrons would not otherwise be able to receive the services if not for a mobilized unit. Such is the case when finances, time-constraints, or availability negates patrons from obtaining services they desire.

One such service is instructional dance classes. There are devices known in the art which provide portable dance equipment, such as disclosed by U.S. Pat. No. 4,696,470 to Fenner and U.S. Pat. No. 6,238,320 to Flanagan. The dance platforms disclosed by Fenner and Flanagan are portable from one location to another. However, these devices do not provide a dance studio having fixtures which are either permanently affixed or otherwise secured into a mobile vehicle. Therefore, the dance equipment disclosed by Fenner and Flanagan are difficult to move and time-consuming to set-up once on site.

It is apparent that it would be desirable to have the necessary instructional dance fixtures secured within a mobile vehicle so that the fixtures are ready for use as soon as the vehicle is securely parked or braced.

Therefore, a need remains for a mobile dance studio which has fixtures, such as a dance floor, a reflective surface, and a balance barre, which are secured within the vehicle such that the location of the dance studio may be easily moved from one location to another for the purpose of providing dance lessons.

The present invention, as detailed hereinbelow, seeks to fulfill this need by providing a vehicle equipped as a mobile dance studio including a dance floor, a reflective surface, a balance barre, and a music system.

### SUMMARY OF THE INVENTION

The present invention provides a mobile dance studio located within a vehicle, the mobile dance studio generally comprising:
(a) a vehicle having an electrical system;
(b) a dance floor;
(c) at least one reflective surface located proximal to the dance floor, the reflective surface being secured to the vehicle;
(d) a music system, the music system being powered by the electrical system; and
(e) a balance barre positioned over the dance floor.

The vehicle may also optionally include an office structure having items such as a desk, a chair, and means for collecting and tracking payment as well as tracking student enrollment, such as a computer or the like.

The vehicle may also optionally include a dressing room in which students may prepare for class by changing into appropriate dance attire.

The vehicle may also optionally include at least one raised platform upon which students may dance or perform.

For a more complete understanding of the present invention, reference is made to the following detailed description and accompanying drawings. In the drawings, like reference characters refer to like parts throughout the views in which:

### BRIEF DESCRIPTION OF THE DRAWINGS

FIG. 1 is a perspective view of a preferred embodiment of the present invention hereof; and

FIG. 2 is a perspective view of the present invention hereof, showing optional features such as an office, a dressing room, and a raised platform.

### DETAILED DESCRIPTION OF THE PREFERRED EMBODIMENT

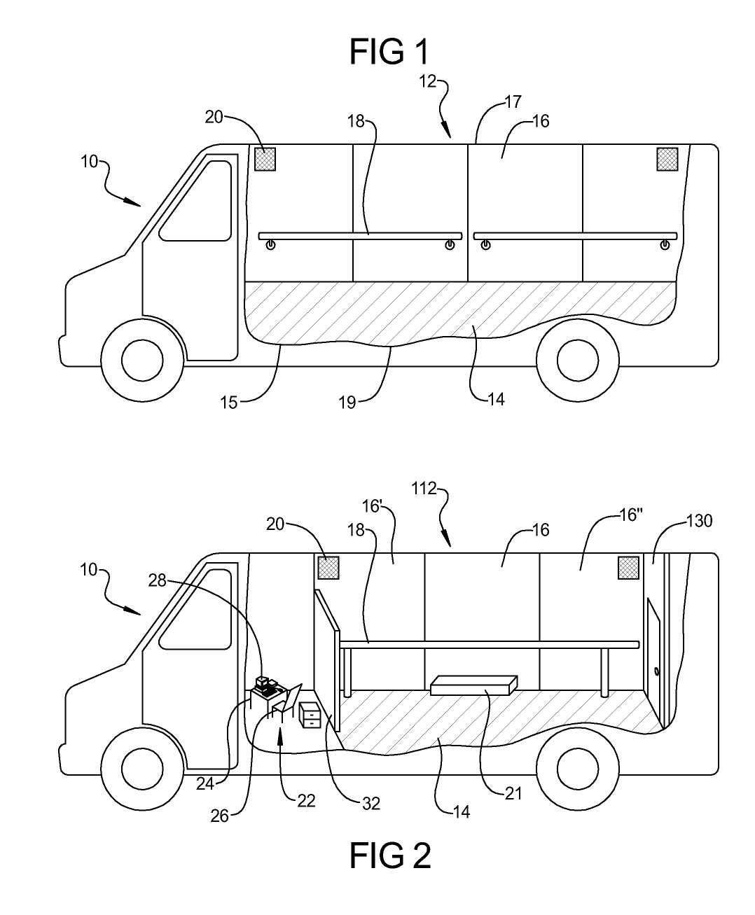

In accordance with the present invention and as shown generally in FIG. 1, there is provided a vehicle 10 outfitted as a dance studio 12. The dance studio 12, generally, comprises a dance floor 14, at least one reflective surface 16, a balance barre 18, and a music system 20.

Any suitable type of vehicle that is sufficiently large may be used. For example, a bus (having the rear seats removed), a recreational vehicle (having most or all furniture removed), a van having a sufficiently tall ceiling, a closed-bed trailer, or the like may be used. As used herein the term “vehicle” can include any type of mobile transportation, such as a boat, a plane, a train, and so on. The vehicle 10 should have a minimal number of windows open to the interior to increase privacy from the outside, or alternatively at least some of the windows should be darkened. The vehicle 10 includes an electrical system which is powered by means well-known in the art, such as the vehicle's battery, the vehicle's alternator, an auxiliary AC outlet such as found in a building, or the like.

As noted, the mobile dance studio 12 comprises a dance floor 14 which is sufficiently large enough to enable dancing and dance instruction. The dance floor 14 is installed in the vehicle 10 and overlies the vehicle floor 15. The dance floor 14 is made from materials which are suitable for dancing upon and which are well-known in the art. For example, the dance floor 14 may be made from wood, laminate flooring, or the like. It is secured to the vehicle floor 15 by any suitable means which are well-known in the art, including but not limited to, fasteners, glue, and so forth. The dance floor 14 can also comprise a floating floor system, which, as understood by one having ordinary skill in the art, includes a plurality of interconnected members sitting atop the vehicle floor 15 and a border (not shown) secured in place about the perimeter of the members to allow the members to expand and contract with changes in temperature.

In addition, at least one reflective surface 16 is provided, such as a mirror or a reflective plastic. Each reflective surface is secured to a first wall 17 of the vehicle at a position which is adjacent, or proximal, to the dance floor 14 so as to aid in the dance instruction by allowing students to view themselves during the lesson. The reflective surface 16 is preferably oriented along a vertical plane. Preferably, the reflective surface 16 extends upwardly from the dance floor 14 towards the ceiling of the dance studio 12. Because of the dangers associated with shattered glass, it may be desirable that the reflective surface 16 be a reflective plastic such as a silverized plastic, reflective plexiglass, or the like. It is also preferable that, in the event that the reflective surface 16 is mounted over a window, the reflective surface 16 have a backside which is non-transparent so as to increase privacy within the mobile dance studio 12. The reflective surface 16 is secured to the wall 17 by any suitable means, such as by using threaded fasteners, bonding agents, or the like. A wall board may also be secured to the wall 17, and the reflective surface 16 may be secured thereto.

When more than one reflective surface 16 is provided, a plurality of reflective surfaces 16,16′,16″,etc. can be mounted adjacent each other to create a single large reflective surface. In addition, the reflective surface 16′ can be mounted on a second wall 19 of the vehicle 10 which is across the dance floor 14 and opposes the first wall 17, such as commonly found in a dance studio.

At least one balance barre 18 is provided to aid in instruction as well. As understood by one having ordinary skill in the art, a balance barre 18 is a stationary handrail that is used during warm up exercises and instruction, such as disclosed in U.S. Pat. No. 4,696,470 to Fenner. The balance barre 18 can be mounted to the first wall 17 of the vehicle 10, mounted to the dance floor 14 and extending upwardly therefrom, mounted to the reflective surface 16, or provided as a movable free-standing balance barre 18. The balance barre 18 is positioned over the dance floor 14 to aid in the dance instruction. The balance barre 18 can be mounted using any suitable means which are well-known in the art, such as fasteners (e.g., bolts, nuts, screws, nails) adhesives, or the like. The balance barre 18 is formed from any suitable material which is well-known in the art, such as wood, metal, fiberglass, or the like. The balance barre 18 is preferably mounted at waist-height and preferably has a diameter of about one and one-half inches.

The mobile dance studio 12 also includes a music system 20 for use during the instructional dance lessons. The music system 20 can be any type which is well-known in the art, such as disclosed in U.S. Pat. No. D350,754 to Sasago, or a boombox style stereo as disclosed in U.S. Pat. No. 310,666 to Yamamoto. When provided, the vehicle 10 may use its factory-installed stereo system as well.

The dance studio 12 can also provide at least one raised platform 21. The raised platform 21 can be used for dancing upon for use in performances, to aid in dance instruction, and so forth. The raised platform 21 should have an upper planar surface which is covered by a suitable dance floor material, such as discussed above, and be oriented along a horizontal plane.

The vehicle 10 can also optionally include an office 22 for organizing information pertinent to the operation of the mobile dance studio 12. Such information includes student enrollment, scheduling, billing, and payments. Students may often sign up for classes and make payments at the time of class, and therefore it is desirable to provide an office 22 for organizing and tracking such information. Because of the nature of the business conducted within the office 22, at least one partition wall 32 segregates the office 22 from the dance studio 12. The partition wall 32 need not extend the entire distance between the vehicle floor 15 and the ceiling of the dance studio 12, however, it is preferable that it be sufficiently high to provide adequate privacy to the office 22. In addition, the office 22 can be enclosed by more than one partition wall 32 if necessary. It is also preferable that the office 22 be located at either the rear or front of the vehicle 10 so as to require as little space as necessary. The partition wall 32 can either be permanently affixed or removably secured within the interior of the vehicle 10. When the partition wall 32 extends from the vehicle floor 15 to the ceiling, then a door (not shown) is provided in the wall 32 for access to the office 22.

As such, the vehicle 10 having a mobile dance studio 12 can have an office 22 including a desk 24, a chair 26, and means for organizing information 28 such as enrollment, scheduling, billing, payments, and the like. The means for organizing 28 may include a traditional paper-based system including an appointment book, a ledger, and so forth. However a computer which utilizes software capable of the same may be used as well.

The vehicle 10 may, also, optionally include at least one dressing room 30 in which students may prepare for class by changing into appropriate dance attire. The dressing room 30 is preferably an enclosed room having walls and a door located within the vehicle 10. The walls and door may be formed from any suitable materials well known to one having ordinary skill in the art. The walls and door need not extend from the floor to the ceiling of the vehicle 10, however, they should be sufficiently high so as to provide adequate privacy within the dressing room 30. A hanging curtain may optionally be used rather than a door. The dressing room 30 may also include a storage area for stowing the students' clothing. The dressing room 30 is preferably located either near the front or the rear of the vehicle 10 so as to require as little space as necessary. In addition, the dressing room 30 should be located so that it does not block or impede access to any required emergency exits.

Similarly, the dance studio 12 of the vehicle 10 is, preferably, sound-proofed with suitable sound-absorbing material and/or insulation to prevent excessive noise from being heard outside the vehicle 10.

In use, the vehicle 10 is driven to the student(s), and the student(s) enter the vehicle 10 through any suitable access door, depending on the type of vehicle 10. The student(s) receive their instructional dance lesson, and, then, leave the vehicle 10. The vehicle 10 can then be driven to the next location to the next student(s). In this regard it is to be appreciated that the vehicle 10 can provide unique services, such as by being driven to a school to provide an on-site after school activity.

As is apparent from the preceding, the present invention provides a mobile dance studio located within a vehicle which generally comprises a dance floor, a reflective surface, a balance barre, and a music system. The dance floor, reflective surface, balance barre, and music system are secured within the vehicle such that the vehicle may easily and quickly be moved from one location to another. The vehicle may optionally also include an office having items such as a desk, a chair, and means for collecting and tracking payment as well as tracking student enrollment. The vehicle may optionally further include a dressing room in which students may prepare for class by changing into appropriate dance attire.

What is claimed is:

1. A mobile dance studio located within a vehicle, the mobile dance studio comprising:
(a) a vehicle having an electrical system;
(b) a dance floor;
(c) at least one reflective surface located proximal to the dance floor, the reflective surface being secured to a first wall of the vehicle;
(d) a music system, the music system being powered by the electrical system; and
(e) a balance barre positioned atop the dance floor and being secured to the vehicle.

2. The mobile dance studio of claim 1 wherein the vehicle is a bus.

3. The mobile dance studio of claim 2 comprising at least one raised platform.

4. The mobile dance studio of claim 3 comprising a plurality of reflective surfaces, at least two of the reflective surfaces being positioned adjacent each other.

5. The mobile dance studio of claim 4 wherein at least one reflective surface from the plurality of reflective surfaces is secured to a second wall, the second wall being positioned across the dance floor and opposed to the first wall.

6. The mobile dance studio of claim 3 wherein the at least one reflective surface comprises a reflective plastic.

7. The mobile dance studio of claim 4 wherein the at least one reflective surface comprises a reflective plastic.

8. The mobile dance studio of claim 5 wherein the at least one reflective surface comprises a reflective plastic.

9. The mobile dance studio of claim 1 comprising at least one raised platform.

10. The mobile dance studio of claim 9 comprising a plurality of reflective surfaces, at least two of the reflective surfaces being positioned adjacent each other.

11. The mobile dance studio of claim 10 wherein at least one reflective surface from the plurality of reflective surfaces is secured to a second wall, the second wall being positioned across the dance floor and opposed to the first wall.

12. The mobile dance studio of claim 9 wherein the at least one reflective surface comprises a reflective plastic.

13. The mobile dance studio of claim 10 wherein the at least one reflective surface comprises a reflective plastic.

14. The mobile dance studio of claim 11 wherein the at least one reflective surface comprises a reflective plastic.

15. The mobile dance studio of claim 1 comprising a plurality of reflective surfaces, at least two of the reflective surfaces being positioned adjacent each other.

16. The mobile dance studio of claim 15 wherein at least one reflective surface from the plurality of reflective surfaces is secured to a second wall, the second wall being positioned across the dance floor and opposed to the first wall.

17. The mobile dance studio of claim 15 wherein the at least one reflective surface comprises a reflective plastic.

18. The mobile dance studio of claim 16 wherein the at least one reflective surface comprises a reflective plastic.

19. The mobile dance studio of claim 1 comprising an office and a dressing room.

20. A mobile dance studio located within a vehicle, the mobile dance studio comprising:
(a) a dance floor;
(b) at least one reflective surface located proximal to the dance floor, the reflective surface being secured to a first wall of the vehicle;
(c) a music system; and
(d) a balance barre positioned atop the dance floor.
